(19) United States
(12) Patent Application Publication
(10) Pub. No.: US 2008/0316433 A1
(43) Pub. Date: Dec. 25, 2008

(54) Beam Switch For An Optical Imaging System

(75) Inventors: Ramon Pascal Van Gorkom, Eindhoven (NL); Oscar Hendrikus Willemsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,602

(22) PCT Filed: Aug. 29, 2005
(86) PCT No.: PCT/IB2005/052815

§ 371 Date: Mar. 2, 2007

(30) Foreign Application Priority Data
Sep. 7, 2004 (EP) 04104302.7

(51) Int. Cl. G02B 26/08; G03B 21/28

(52) U.S. Cl. 353/30; 359/223; 353/33

(57) ABSTRACT

The present invention relates to a beam switch (1) for an optical imaging system. An at least partially reflecting foil (2), is sandwiched in a slanted position in a space between a first plate (3) and a second plate (4). The switch (1) further comprises a foil electrode (6) associated with said foil (2) and a first transparent electrode (5) associated with said first plate (3) and/or a second electrode (7) associated with said second plate (4). Application of a first voltage potential difference between said foil electrode (6) and at least one of said plate electrodes (5, 7) is arranged to attract said foil (2) towards a position essentially parallel with said first plate (3), in order to reflect light incident on said first plate (3) in a first direction. Application of a second voltage potential difference is arranged to allow said foil (2) to take said slanted position, reflecting light incident on said first plate (3) in a second direction.

### BACKGROUND OF THE INVENTION

1. Field of the Invention

The present patent application relates to the field of beam switches for optical imaging systems of display devices.

2. Description of the Related Art

One of the options to realize a small handheld projector type display is to use (diode) laser light sources in combination with a scanning/modulating device. A relatively simple embodiment could comprise three (RGB: Red, Green, Blue) laser diodes and a fast electromechanical mirror scanner. For such a device the diodes must be intensity modulated at frequencies of typically 10 MHz. The presently available red and blue lasers meet this requirement. A complication arises with the green lasers. They consist of an IR diode laser which pumps a frequency doubled YAG (yttrium-aluminum-garnet) laser. The maximum switching frequency of the YAG laser is limited to about 3 kHz. This hampers the realization of a full color display with a mechanical scanner.

A different approach is to use a one-dimensional array of individual beam switches (e.g. 500 individual beam switches). An example of such an array which has been demonstrated by Silicon Light Machines is the Grating Light Valve (GLV). This array is based on switchable MEMS (Micro-Electrical-Mechanical-System) gratings. A laser beam is projected onto the grating. The zero order-diffracted light is blocked. Some of the higher orders are collected and projected onto a screen. The switching speed combined with the multiplicity of switches is sufficient for video projection. A drawback of the GLV is that the mechanical details are rather small (1-2 μm) and that the projection optics must be focused on the projection screen. The latter is due to the fact that the light leaves the grating under different angles and must be properly recollected on the screen by the imaging optics.

Another type of light switch is based on the well-known fact that light travels at different speeds in different materials. Change of speed results in refraction. The relative refractive index between two materials is given by the speed of an incident light ray divided by the speed of the refracted ray. If the relative refractive index is less than one, as is the case e.g. when a ray of light passes from a glass block to air, then the ray of light will be refracted towards the surface. Angles of incidence and reflection are normally measured from a direction normal to the interface. At a particular angle of incidence “i” the refraction angle “r” becomes 90° as the light runs along the surface of the glass block. The critical angle “i” can be calculated as “sin i=relative refractive index”. If “i” is made even larger, then all of the light is reflected back inside the glass block. This phenomenon is called total internal reflection. Because refraction only occurs when light changes speed, the incident radiation emerges slightly before being totally internally reflected, and hence a slight penetration (roughly one micron) of the interface occurs. This phenomenon is called “evanescent wave penetration”. By interfering with (i.e. scattering and/or absorbing) the evanescent wave it is possible to prevent (i.e. frustrate) the total internal reflection phenomena.

An optical switch based on this phenomenon is described in WO 0137627 which relates to an optical switch for controllably switching an interface between a reflective state in which incident light undergoes total internal reflection and a non-reflective state in which total internal reflection is prevented. In one such switch an elastomeric dielectric has a stiffened surface portion. An applied voltage moves the stiffened surface portion into optical contact with the interface, producing the non-reflective state. In the absence of a voltage the separator moves the stiffened surface portion away from optical contact with the interface, producing the reflective state.

A drawback of the above described switch according to WO 0137627 is that all the light needs to be scattered in the off state, or else the dark level will not be very dark, deteriorating the contrast, thus decreasing the quality of the resulting image.

### SUMMARY OF THE INVENTION

Taking the above into mind, it is an object of the present invention to provide an improved beam switch for an optical imaging system, by which an image can be projected onto a screen essentially without contrast degradation.

This and other objects are achieved in accordance with the characterizing portion of claim 1.

Thanks to the provision of an at least partially reflecting foil, which is sandwiched in a slanted position in a space between a first and a second plate, said first plate being at least partially transparent; a foil electrode associated with said foil; and a first transparent electrode associated with said first plate and/or a second electrode associated with said second plate; and application of a first voltage potential difference between said foil electrode and at least one of said plate electrodes being arranged to attract said foil towards a position essentially parallel with said first plate, in order to reflect light incident on said first plate in a first direction; and application of a second voltage potential difference between said foil electrode and at least one of said plate electrodes being arranged to allow said foil to take said slanted position between said first plate and said second plate, in order to reflect light incident on said first plate in a second direction, said second direction being different from said fist direction, a beam switch for an optical imaging system by which an image can be projected onto a screen essentially without contrast degradation can be achieved.

Preferred embodiments are listed in the dependent claims.

### BRIEF DESCRIPTION OF THE DRAWINGS

In the drawings, wherein like reference characters denote similar elements throughout the several views:

FIG. 1 discloses a schematic illustration of a single switch in an “off” state;

FIG. 2 discloses a schematic illustration of the switch according to FIG. 1 in an “on” state, rest position of the switch;

FIG. 3a shows a first alternative embodiment of a single switch;

FIG. 3b shows a second alternative embodiment of a single switch;

FIG. 4 illustrates schematically one possible embodiment of a one-dimensional array built up of beam switches according to FIG. 1;

FIG. 5a shows in a top view an example of an optical imaging system containing the one-dimensional array of beam switches according to FIG. 4;

FIG. 5b shows in a side view the optical imaging system according to FIG. 5a;

FIG. 6 discloses a first embodiment of an optical imaging system that generates fall color images using the one-dimensional array of foil based beam switch modulators;

FIG. 7 discloses a second embodiment of an optical imaging system that generates full color images using the one-dimensional array of foil based beam switch modulators;

FIG. 8 discloses a third embodiment of an optical imaging system that generates full color images using the one-dimensional array of foil based beam switch modulators.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION OF THE PRESENTLY PREFERRED EMBODIMENTS

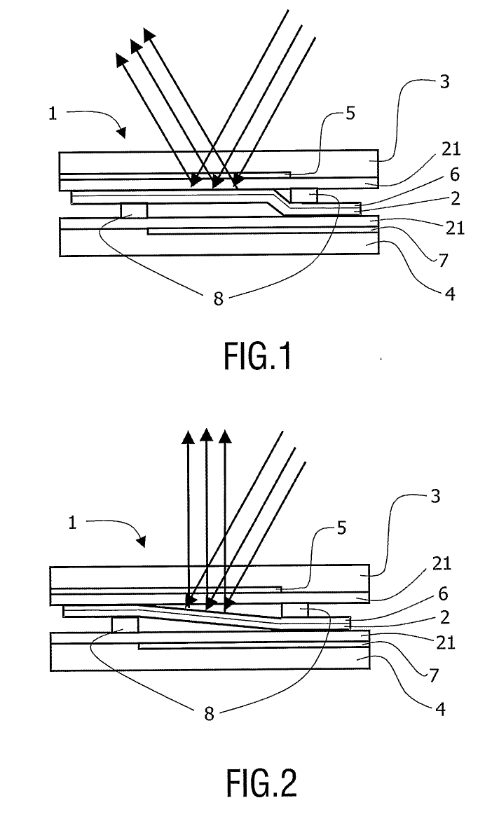

FIG. 1 shows a schematic illustration of a single beam switch 1, i.e. one pixel of an optical imaging system. The beam switch 1 consists of a reflective foil 2 which is sandwiched between a first 3 and a second 4 plate, e.g. glass plates, at least the upper one (first plate 3) being at least partially transparent for light from a light source. The lower one (second plate 4) can be non-transparent. The foil is coated with a reflective coating, e.g. a metal. For example, a commercially available capacitor foil from Steiner can be used, e.g. an aluminum covered capacitor foil. The reflective foil 2 is coated with a transparent foil electrode 6. At least one of the plates 3, 4 is equipped with electrodes, either the upper (first) plate 3 is provided with a first transparent electrode 5 (e.g. ITO, Indium-Tin-Oxide) or the lower (second) plate 4 is be provided with a transparent or alternatively non-transparent second electrode 7, or alternatively both plates 3, 4 are provided with electrodes 5, 7 as described above. The electrodes 5, 6, 7, can also be provided with extra metalization in certain areas, in order to lower the resistance of the ITO. On top of the ITO and metal a dielectric layer 21, such as SiO₂ can be arranged. In principal there only needs to be an electrode on either of the first plate 3 and second plate 4 and one electrode on the foil 2. Alternatively the foil 2 can be electrically conductive, i.e. in effect be the electrode itself. If an electrode is present on the first plate 3 it is preferably transparent, however it can also be semi-transparent or non-transparent. In the latter case the electrode must not be in the direct path of the light beam. The reflective foil 2 is sandwiched in a slanted position between the first and second plates 3, 4 by means of at least one spacer 8. The at least one spacer 8 can be arranged on the dielectric layers 21. The reflective foil 2 can be actuated by applying proper voltages to the respective electrodes 5, 6, 7. The electrode 5 of the first plate 3 can also be confined to e.g. an area close to the spacer 8, however this is not a preferred embodiment. Light from the light source can enter the beam switch immediately or alternatively be coupled into the beam switch 1 by means of a prism. If the reflective foil 2 is brought into contact with the first plate 3 the light is reflected in a first direction. If the reflective foil 2 is in its slanted position the light is reflected in a second direction, which second direction is different from the first direction. This is schematically shown in FIG. 2, which illustrates the rest position of the switch 1. The switching device 1 might be integrated directly upon the surface of a driver chip. It is obvious to the person skilled in the art that the roles of the first and second plates 3, 4 can be reversed.

When the pixel is in the “off” state (FIG. 1) the reflective foil 2 is drawn to the upper (first) plate 3 by applying the proper voltages to the foil electrode 6 and at least one of the plate electrodes 5, 7 or drawn to the lower (second) plate 4 by applying a large enough voltage difference between the foil electrode 6 and at least one of the plate electrodes 5, 7, i.e. the foil 2 is bent or completely deflected towards one of the two plates 3, 4, i.e. towards a position essentially parallel with the first plate 3. All light is reflected in the first direction. When the pixel is in the “on” state (FIG. 2), the reflective foil 2 is allowed to take the slanted position between the first plate 3 and the second plate 4, i.e. to the rest position of the switch 1. In this state the mirror surface of the foil 2 is flat and inclined at an angle to the surface. This state is achieved with no voltage differences applied between the foil electrode 6 and the plate electrodes 5, 7. This means that light incident on the beam switch 1 will travel in different directions depending on the state of the foil 2 of the beam switch 1. In principle there only need to be electrodes on either of the two plates 3, 4. However, it can be advantageous to have it on both, for e.g. switching speed.

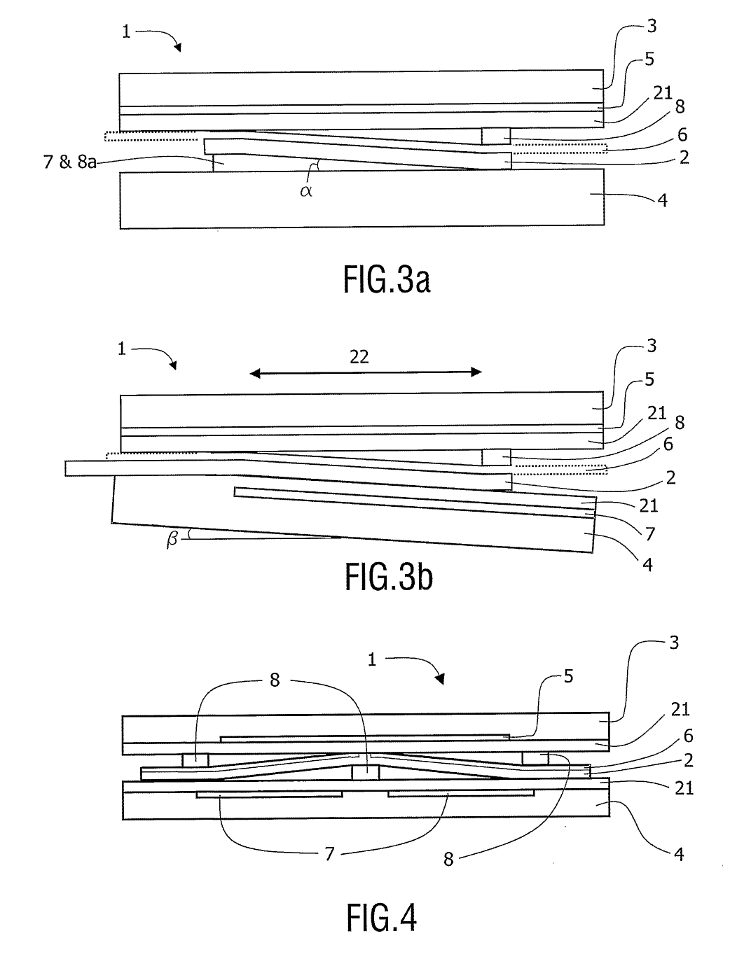

FIG. 3a shows a first alternative embodiment of the beam switch 1. The first plate 3 and the foil 2 are identical to the embodiment described above with reference to FIGS. 1 and 2, but the second plate 4 has changed. In this embodiment a spacer 8a is arranged on the second plate 4, the thickness of which is not constant, but it decreases from a finite height to zero, i.e. arranged such that a backing support is provided for the foil 2 when in the slanted position. With such design of the spacer 8a the foil 2 can be pulled to this spacer 8a by electrostatic force, giving it a fixed position. The advantages of this embodiment over the previous embodiment is that the on state can be achieved faster because the foil 2 can be pulled to this state instead of it having to relax back to this state. Furthermore any surface charging effects will have less influence on the device because two well-defined states can be achieved by applying large enough voltage differences between the foil electrode 6 and either of the plate electrodes 5, 7.

From test measurements on prototypes of the device described above, it appeared that the angle α (see FIG. 3a) should preferentially be in the order of 2 degrees. The maximal height of this spacer 8a is determined by the method of fabrication. For a lithographic process this is in the order of a few microns to a few tens of microns. A smaller thickness is also possible, but this decreases the width of the spacer 8a and, hence, of the pixel.

Although the spacer 8a is preferentially made using lithographic techniques, it is also possible to make them by micro-machining and optical grinding and milling. The spacer 8a is preferentially made out of a metal. In that case it will serve as the electrode 7 on the second plate 4. Optionally an insulating layer (for instance SiO₂) is deposited on top of it. If the spacer 8a is not a metal, an electrode should be deposited underneath the spacer 8a or on top of it.

FIG. 3b shows a second alternative embodiment of the beam switch 1. In this case the first plate 3 and the second plate 4 have the same layer structure as is depicted in FIG. 1, but they are positioned at an angle β with respect to each other. Of course, the angle α (of FIG. 3a) and the angle β (of FIG. 3b) have a similar value.

In a preferred embodiment the second plate 4 needs an additional processing step. Part of the originally flat second plate 4 needs to be removed by etching or grinding. By doing this, a flat surface at one side next to the active pixel area 22 is created (in FIG. 3b this is the left side), at which the second plate 4 presses the foil 2 onto the first plate 3. At the other side of the pixel the second plate 4 presses the foil 2 onto the spacer 8 of the first plate 3.

Another option (not shown) is to take a flat second plate 4 and to position this flat second plate 4 with its edge exactly at the boundary of a pixel. In yet another embodiment (not shown) the second plate 4 is flat and very thin (order of 100 μm). By evacuation of the volume between space and foil 2 the second plate 4 is pressed to the first plate 3. Depending on elasticity and plate thickness, the correct angle between the two plates 3, 4 is obtained.

As illustrated in FIGS. 3a and 3b in accordance with the alternative embodiments a beam switch 1 for an optical imaging system can be achieved where the second plate 4 at a side thereof facing the foil 2 either, as illustrated in FIG. 3a, comprises a spacer 8a arranged such that a backing support is provided for said foil 2 when in the slanted position or, as illustrated in FIG. 3b, is arranged such that the second plate 4 itself provides a backing support for said foil 2 when in the slanted position.

FIG. 4 schematically shows an example of a one-dimensional array of beam switches 1. In this particular embodiment for simplicity the array simply consist of two beam switches 1. The spaces between the reflective foil 2 and the plates 3, 4 can be filled with any gas or can be made vacuum. FIG. 4 illustrates the most straightforward way of achieving a one-dimensional array of beam switches 1. With the embodiment of FIG. 4 there are actually three directions in which the light will be traveling, because there are two orientations of the beam switches 1 in the array. Therefore using the embodiment in accordance with FIG. 4 in an optical imaging system it will be necessary to use a double pinhole diaphragm. However, there are also other ways. For example, it is also possible to place the pixels at an angle, e.g. 450, or place them rotated over 90°. The disadvantage of the latter is that there will be some amount of mechanical cross talk between neighboring pixels. For the latter an associated optical imaging system will need a diaphragm having a single pinhole, while for the other two it needs to be a double pinhole.

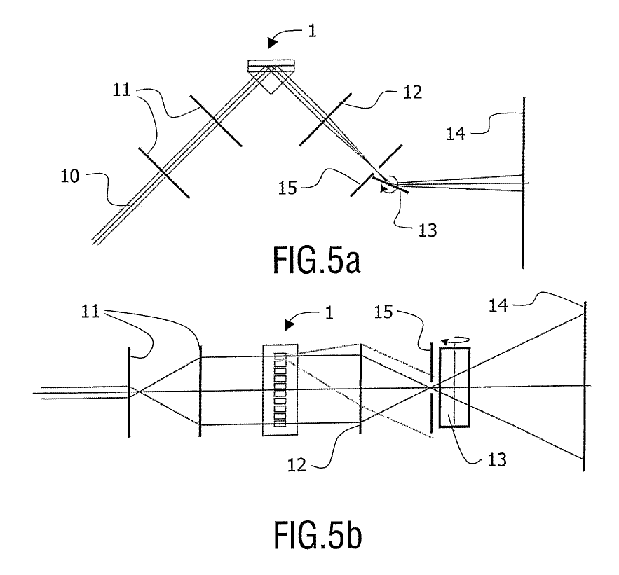

An optical imaging system utilizing at least one beam switch 1 to generate a projected image is envisaged. For example a one-dimensional optical imaging system. Such an optical imaging system is illustrated in FIGS. 5a and 5b.

The optical imaging system consists of a laser, a LED, a UHP (Ultra-High Performance) lamp or other light source (not shown) for producing a light beam 10. The light beam 10 is expanded in one direction using beam shaping optics 11, e.g. composed of two cylindrical lenses, to illuminate a one-dimensional array of beam switches 1, which is arranged to receive the expanded light beam and modulate it to form a line image. After passing the array of beam switches the beam of reflected light from the “on” state is led through a projection lens 12 and a pinhole diaphragm 15. The beam switches 1 and the pinhole diaphragm 15 are placed approximately in the focal planes of the projection lens. The light from beam switch pixels in the “on” state passes the pinhole diaphragm 15 and is projected on the screen 14. In the “off” state the light is reflected in the first direction and essentially the portion thereof entering the projection lens 12 will be blocked at the pinhole diaphragm 15. Any scattered light from beam switch pixels in the “off state” is intercepted either by the projection lens 12 aperture or, if passing that aperture, by the pinhole diaphragm 15 aperture. It is obvious for the person skilled in the art that the positioning of the pinhole diaphragm 15 aperture is dependent on how the beam switches 1 are arranged with respect to the incoming light, why the positions illustrated in the drawings are only example positions. The important aspect of the pinhole diaphragm 15 aperture being to block the specular reflected light from the beam switches 1. As an alternative to a pinhole diaphragm 15 aperture it is also possible to use a beam stop for the specular direction. The result is a vertical (or horizontal) modulated bar line image on the screen. This line image bar can be scanned to form a two-dimensional image by using a slow mirror scanner 13. In the case of a laser light source, the depth of focus is very large, in the ideal case indefinitely large. Since the distance between beam switches 1 and the projection lens 12 is almost equal to the focal length of the projection lens 12, the image is focused almost at infinity. If a lower quality light source is used, the system must be properly focused on the screen 14, i.e. meaning that the distance between beam switches 1 and projection lens 12 must be adapted. The switching speed of the foil based beam switch device 1 is sufficiently high for video modulation. The efficiency for pixels in the “on” state is close to 100%.

An actual optical imaging system display device should reproduce an image using at least three (primary) colors, e.g. Red, Green and Blue. There are many options to achieve this: e.g. one array and line sequential color, one array and frame sequential color, one array and scrolling color, three (or more) arrays and simultaneous color, . . . etc. Detailed embodiments concerning color and grayscale reproduction will be described in the following.

In the following is described a number of embodiments of optical imaging systems that generates full color images with a one-dimensional array of foil based beam switch modulators 1 as described earlier. The embodiments have a number of conditions in common that are listed below:

The light is generated in three separate branches R, G, B that each include a one-dimensional array of foil based beam switch modulators 1;

The light path in each of the branches R, G, B is optimized for transmission of the color of light in that particular branch;

The arrays of foil based beam switch modulators 1 are positioned such that they lie in the same plane when seen from the direction of the projection lens 12;

The projection lens 12 images the glass-foil interface of the foil based beam switch modulators 1 onto the screen 14;

A diaphragm 15 is positioned at the focal plane of the projection lens 12 and between the projection lens 12 and a rotation mirror 13.

The details of these conditions will be given below.

Embodiment one: architecture with a dichroic recombination cube 17.

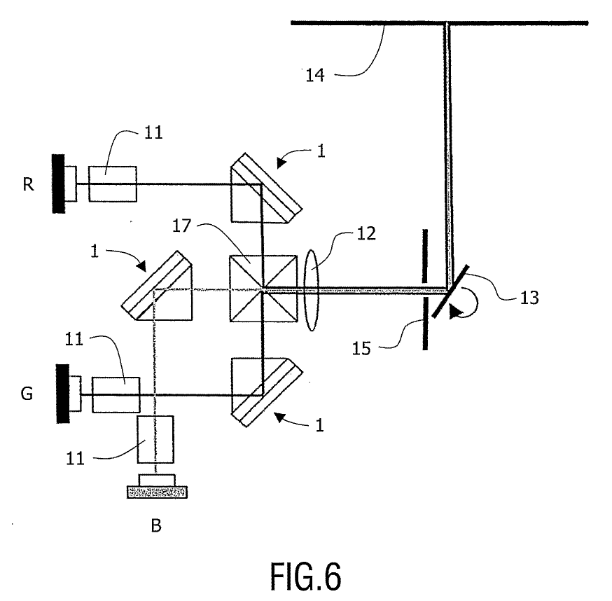

The first embodiment is illustrated in FIG. 6.

In the set-up the light is formed in three branches R, G, B, each of them corresponding to one of the display primaries. The optical elements in the branches R, G, B are optimized for the wavelength that is used in the branches. For instance, the beam shaping optics 11 that takes care that a thin line of parallel light illuminates the beam switches 1 is covered with antireflection coatings that are optimized for the red laser beam. The light in the three branches R, G, B is recombined with a dichroic cube 17. The position of the three foil array blocks 1 is such that they are in the same plane, when viewed from the direction of the projection lens 12. The projection lens 12 is positioned such that it images the glass-foil interface of all three array panels 1 onto the screen 14. A diaphragm 15 is positioned at the focal plane of the projection lens 12 and the rotating mirror 13 to enhance the contrast.

Note that the dichroic cube 17 can be quite small in the direction of the plane of FIG. 6, since the light from the foil based beam switch array 1 is almost parallel in the case of a laser light source. Only in the direction perpendicular to this plane the cube 17 needs to be elongated as long as the length of the foil based beam switch array 1. This makes the dichroic cube 17 much cheaper than the ones used in HTPS LCD projectors.

Embodiment two; architecture with dichroic recombination plates 18.

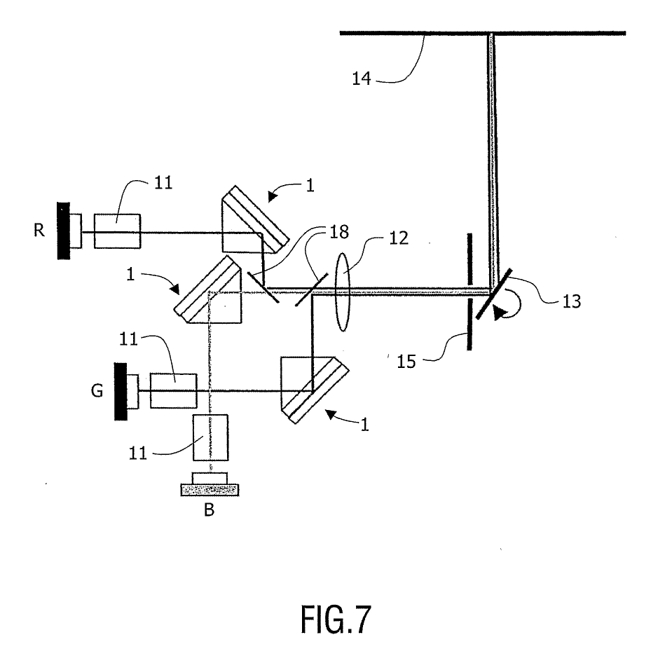

A second embodiment is illustrated in FIG. 7. The main difference from the first embodiment according to FIG. 6 is that dichroic plates 18 have been used instead of a dichroic recombination cube 17. This has some consequences for the folding of the light path, which can be observed from FIG. 7.

Embodiment three; architecture with folding mirror 19.

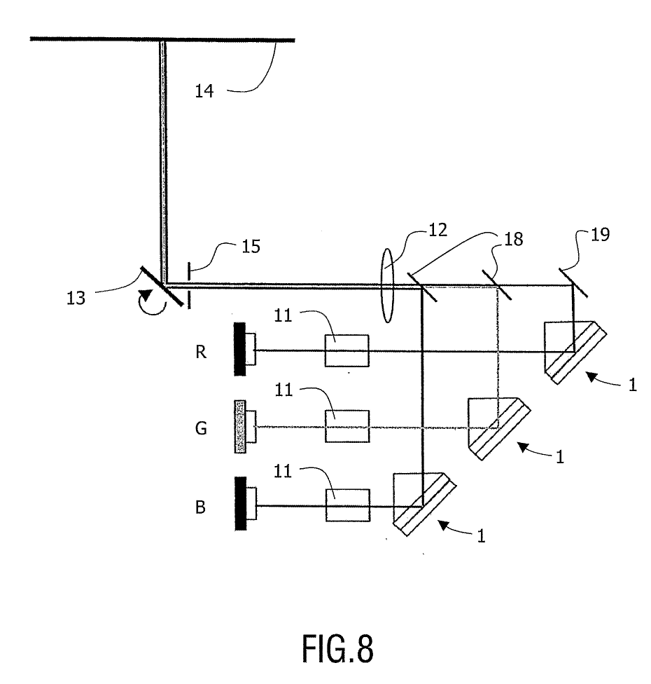

A third embodiment is illustrated in FIG. 8. When compared to embodiment two (FIG. 7) it uses an extra folding mirror 19. Although this adds to the bill of material it also has some advantages. First, the three foil based beam switch arrays 1 can be positioned in one plane. Although drawn separately in FIG. 8, they can be combined onto a single plate. This can be beneficial for manufacturing and it offers an automatic alignment of the three foil based beam switch arrays 1. Second, the illumination path of the three foil based beam switch arrays 1 is parallel. This enables the combination of optical components into one piece of material. Third, the beam path is folded, which results in a very compact device.

General remarks for the three embodiments described above.

Since all proposed optical paths R, G, B are chosen such that the three beams overlap on the screen, the light path of the individual colors can be interchanged.

Although a one-dimensional array of beam switches has been described in the examples give above it is obvious to the person skilled in the art that the above teachings can be used with a zero-dimensional (point i.e. one pixel beam switch) through the addition of an extra scan mirror, i.e. using two scan mirrors. It is also obvious that if a two-dimensional array of beam switches is used, no scan mirrors are needed. In case of a setup using a two-dimensional array of beam switches, either an active matrix or a passive matrix can be used. Further, in addition to using a separate set of beam switches for each color, as described above, optical imaging systems can also be realized using the proposed beam switches where color information is modulated sequentially on a single set of beam switches, or alternatively the colors are done in adjacent rows on a single set of beam switches. In the latter case it will be necessary either to add color filters or carefully aim the light beams onto the correct pixels.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A beam switch for an optical imaging system, comprising:
an at least partially reflecting foil, which is sandwiched in a slanted position in a space between a first and a second plate, said first plate being at least partially transparent; and
a foil electrode associated with said foil; and
a first transparent electrode associated with said first plate and/or a second electrode associated with said second plate; and
application of a first voltage potential difference between said foil electrode and at least one of said plate electrodes (5, 7) being arranged to attract said foil towards a position essentially parallel with said first plate, in order to reflect light incident on said first plate in a first direction; and
application of a second voltage potential difference between said foil electrode and at least one of said plate electrodes (5, 7) being arranged to allow said foil to take said slanted position between said first plate and said second plate, in order to reflect light incident on said first plate in a second direction, said second direction being different from said fist direction.

2. The beam switch for an optical imaging system of claim 1, characterized by said reflecting foil being sandwiched in said slanted position in said space between said plates (3, 4) by means of at least one spacer.

3. The beam switch for an optical imaging system of claim 2, characterized by said second plate at a side thereof facing said foil either being arranged such or comprising a spacer arranged such that a backing support is provided for said foil when in said slanted position.

4. The beam switch for an optical imaging system of claim 1, characterized by said electrodes (5, 6, 7) being Indium-Tin-Oxide electrodes.

5. The beam switch for an optical imaging system of claim 4, characterized by said electrodes (5, 6, 7) being at least partially provided with extra metalization, in order to lower the resistance of the Indium-Tin-Oxide.

6. The beam switch for an optical imaging system of claim 1, characterized by a dielectric layer being provided on top of each of said electrodes (5, 6, 7).

7. The beam switch for an optical imaging system of claim 6, characterized by said at least one spacer being arranged on said dielectric layers.

8. The beam switch for an optical imaging system of claim 1, characterized by a prism being arranged on said first plate, through which prism light incident on said first plate is arranged to pass.

9. An array of beam switches for an optical imaging system, characterized in that it comprises a plurality of optical beam switches according to claim 1.

10. The array of beam switches for an optical imaging system of claim 9, characterized by said first plate being common to all beam switches of said array of beam switches.

11. An optical imaging system, comprising:
at least one light source for producing at least one light beam;
beam shaping optics arranged to shape said at least one light beam;
characterized in that it comprises at least one beam switch according to claim 1, arranged to receive said shaped at least one light beam and modulate it to form an image;
a projection lens for projecting said image.

12. The optical imaging system of claim 11, characterized by:
said beam shaping optics being arranged to shape said at least one light beam to a point;
said at least one beam switch being arranged to receive said at least one light beam and modulate it to form a point image;
said projection lens being arranged for projecting said point image.

13. The optical imaging system of claim 12, characterized by it further comprising:
one mirror scanner arranged to scan consecutive said point images to form a one-dimensional image.

14. The optical imaging system of claim 12, characterized by it further comprising:
two mirror scanners arranged to scan consecutive said point images to form a two-dimensional image.

15. The optical imaging system of claim 11, characterized by:
said beam shaping optics being arranged to expand said at least one light beam in one direction;
said at least one beam switch being arranged to receive said expanded at least one light beam and modulate it to form a line image;
said projection lens being arranged for projecting said line image.

16. The optical imaging system of claim 15, characterized by it further comprising:
a mirror scanner arranged to scan consecutive said line images to form a two-dimensional image.

17. The optical imaging system of claim 11, characterized by:
said beam shaping optics arranged to expand said at least one light beam in two directions;
said at least one beam switch being arranged to receive said expanded at least one light beam and modulate it to form a two-dimensional image;
said projection lens being arranged for projecting said two-dimensional image.

18. The optical imaging system of claim 11, characterized by:
three separate light sources for producing three separate light beams;
beam shaping optics arranged to shape each respective light beam;
a respective array of beam switches arranged to receive each respective shaped light beam and modulate it to form a respective image segment;
means for combining said respective images segments to one image segment;
a projection lens for projecting said combined image segment.

19. The optical imaging system of claim 18, characterized by said beam shaping optics being arranged to shape each respective light beam to a respective point;
said respective array of beam switches being arranged to receive each respective shaped light beam and modulate it to form a respective point image;
said means for combining said respective images segments to one image segment being arranged to combine said respective point images to one point image;
said projection lens being arranged for projecting said combined point image.

20. The optical imaging system of claim 19, characterized by it further comprising:
a mirror scanner arranged to scan consecutive said combined point images to form a one-dimensional image.

21. The optical imaging system of claim 18, characterized by it further comprising:
two mirror scanners arranged to scan consecutive said combined point images to form a two-dimensional image.

22. The optical imaging system of claim 18, characterized by said beam shaping optics being arranged to expand each respective light beam in one direction;
said respective array of beam switches being arranged to receive each respective expanded light beam and modulate it to form a respective line image;
said means for combining said respective images segments to one image segment being arranged to combine said respective line images to one line image;
said projection lens being arranged for projecting said combined line image.

23. The optical imaging system of claim 22, characterized by it further comprising:
a mirror scanner arranged to scan consecutive said combined line images to form a two-dimensional image.

24. The optical imaging system of claim 18, characterized by said beam shaping optics arranged to expand each respective light beam in two directions;
said respective array of beam switches being arranged to receive each respective expanded light beam and modulate it to form a respective two-dimensional image;
said means for combining said respective images segments to one image segment being arranged to combine said respective two-dimensional images to one two-dimensional image;
said projection lens being arranged for projecting said combined two-dimensional image.

25. The optical imaging system of claim 18, characterized by said means for combining said respective images to one image being a dichrioc cube prism.

26. The optical imaging system of claim 18, characterized by said means for combining said respective images to one image being dichroic plate mirrors.

27. The optical imaging system of claim 18, characterized by said means for combining said respective images to one image being a combination of dichroic plate mirrors and at least one folding mirror.

28. The optical imaging system of claim 11, characterized by a diaphragm being arranged in a light path of said optical imaging system.

29. The optical imaging system of claim 11, characterized by a beam stop being arranged in a light path of said optical imaging system.
